(19) United States
(12) Patent Application Publication
(10) Pub. No.: US 2026/0023346 A1
(43) Pub. Date: Jan. 22, 2026

(54) DEVICE FOR COORDINATED ACTUATION OF TWO FUNCTIONS OF A TIMEPIECE

(71) Applicant: RICHEMONT INTERNATIONAL SA, Villars-sur-Glâne (CH)

(72) Inventor: Martin CRETEGNY, Genève (CH)

(21) Appl. No.: 18/996,316

(22) PCT Filed: Jul. 5, 2023
(86) PCT No.: PCT/IB2023/056956

§ 371 Date: Jan. 17, 2025

(30) Foreign Application Priority Data
Aug. 24, 2022 (CH) CH000987/2022

(51) Int. Cl. G04B 19/02

(52) U.S. Cl. CPC G04B 19/025

(57) ABSTRACT

The device for coordinated actuation of two functions of a timepiece comprises one or a plurality of cams (7; 51, 53) arranged to be driven by the movement of the timepiece and of which the respective profile or profiles each comprise a discontinuity (9; 52, 53); and a first (11a, 11b; 49, 61) and a second (13a, 13b; 63) transmission member each comprising a cam follower (11a, 13a; 61, 64), the cam follower (11a; 61) of the first transmission member being arranged to cooperate with the profile of the cam (7) or of a first (51) of the cams (51, 53) and to fall periodically into the discontinuity (9; 52) of the profile of the cam (7) or of said first (51) of the cams (51, 53), the cam follower (13a; 64) of the second transmission member being arranged to cooperate with the profile of the cam (7) or of a second (53) of the cams (51, 53) and to fall periodically, with the same period as the falls of the cam follower (11a; 61) of the first transmission member, into the discontinuity (9; 54) of the profile of the cam (7) or of the second (53) of the cams (51, 53), the falls of the cam follower (11a; 61) of the first transmission member being offset in time with respect to those of the cam follower (13a; 64) of the second transmission member.

A first object of the present invention is a device for actuating two functions of a timepiece in a coordinated manner. By way of example, the two functions actuated by the device which is the object of the invention can be a time display function and an animation function respectively. The two functions can be implemented by two different mechanisms or by the same mechanism. The present invention has as a second object a timepiece, in particular a watch, which comprises two functions and a device for actuating the two functions in a coordinated manner.

In particular, the first object of the present invention is a device for coordinated actuation of two timepiece mechanisms, the two mechanisms each comprising a mobile, and the device comprising:
a cam referred to as a “snail” arranged to be driven by the movement of the timepiece and comprising a rising profile terminating in a drop;
a first and a second transmission member each comprising a pivoted toothed sector and a cam follower, the cam followers of the first and of the second transmission member both being arranged to cooperate with the profile of the snail, and the toothed sectors being respectively kinematically connected to the two mobiles;
return means arranged for returning the cam followers of the first and second transmission members against the profile of the snail;
the toothed sector of each of the transmission members being arranged in order, during each revolution of the snail, to pivot alternately in one direction and the other from an extreme angular position associated with the tip of the profile of the snail to an opposite extreme angular position.

### PRIOR ART

Timepieces are already known which comprise a mechanism serving to provide time information and which is associated with another mechanism producing an animation. The patent document CH 55403, in particular, describes a cuckoo clock which comprises a mechanism with two bellows which is controlled by the going train of the clock and which is arranged to emit, upon each passage of the hour, an alternation of two notes evoking the song of the cuckoo. This known clock further comprises an animation formed by figures disposed on the front of the clock and which are caused to move by a mechanism which is also driven by the going train of the clock. According to this earlier document, the animation mechanism and the song of the cuckoo are actuated by the same mechanism so that the period during which the animation is produced is superimposed exactly on the period when the cuckoo song is emitted.

According to this example, it will be understood that the cuckoo song is likely to draw the attention of someone looking at the animation but that the animation cannot serve to warn the viewer of an event relating to the time indication.

There is a need for timepieces in which the “coordination between the time indication and animation” is not limited to ensuring that the time indication and the animation take place at the same time, but consists just as much of regulating successive sequences as simultaneous movements, a little as if it were a matter of choreography in which the beauty of the show is dependant on the extreme precision with which it unfolds.

### BRIEF DESCRIPTION OF THE INVENTION

An aim of the present invention is to overcome the disadvantages of the prior art which have just been explained. The present invention achieves this aim as well as others by providing a device for coordinated actuation in accordance with the accompanying claim 1.

By means of the claimed features, the device for coordinated actuation of two functions of a timepiece, which is the object of the invention, makes it possible to ensure that the triggering of one of the two functions occurs at the desired moment in the unfolding of the operations of the other function.

### BRIEF DESCRIPTION OF THE FIGURES

Other features and advantages of the present invention will become clear upon reading the following description, given solely by way of non-limiting example and made with reference to the attached drawings in which:

FIGS. 1A and 1B are both perspective views, from different angles, of a device for coordinated actuation according to a first embodiment of the invention;

FIGS. 2A, 2B, 2C and 2D are schematic plan views of the device for coordinated actuation according to the first embodiment of the invention at four successive moments just before, during and just after the fall of the two cam followers into the drop of the profile of the snail;

FIG. 3A is a perspective view of a device for coordinated actuation of a retrograde display and of an animation, according to a second embodiment of the invention;

FIG. 3B is a plan view of the device for coordinated actuation according to the second embodiment of the invention;

FIGS. 3C to 3F are schematic plan views of the device for coordinated actuation according to the second embodiment of the invention at four successive moments.

### DETAILED DESCRIPTION OF SEVERAL EMBODIMENTS

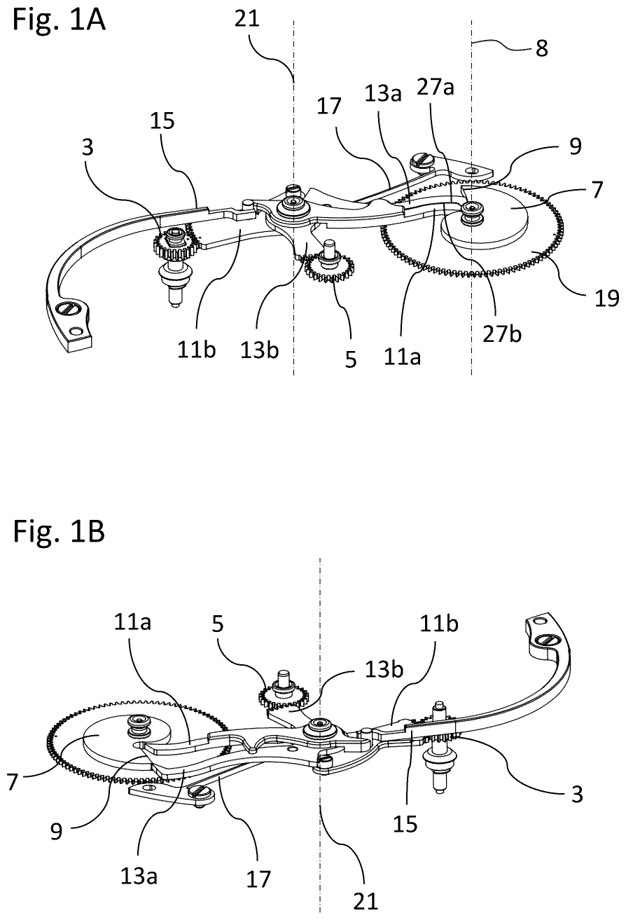

Attached FIGS. 1A and 1B are two perspective views, from different angles, of a device for coordinated actuation of two functions of a timepiece, more particularly of two mechanisms of the timepiece implementing these two functions respectively. This device is in accordance with a first embodiment of the invention. The two mechanisms which the device is intended to actuate are not shown, except for two mobiles (referenced 3 and 5) which each appertain to one of the mechanisms. It can be seen that the mobiles 3 and 5 are pinions in the illustrated example. Depending on the type of mechanisms to be actuated, each of the pinions 3, 5 can e.g. serve to actuate the mechanism directly or to wind a mainspring which is itself dedicated to the actuation of this mechanism. For clarification, in the present example, the two mechanisms which the device in accordance with the invention is intended to actuate in a coordinated manner can take the form respectively of an animation, e.g. of the automaton type, and of a retrograde display of the time. In this case, the animation could be driven by the pinion 3, while the retrograde display of the time would be arranged to be driven by the pinion 5. “Animation” is to be understood to mean a mechanism or a function with a purely aesthetic and/or entertaining function (thus excluding any mechanism or function intended to display a measured magnitude) involving displacements of one or a plurality of mechanical elements. When the animation imitates the movements of one or a plurality of living beings it constitutes an automaton.

FIGS. 1A and 1B also show a cam of the type referred to as a “snail” (referenced 7). The snail 7 is arranged to be driven about an axis 8 by the movement of the timepiece (not shown) via the wheel 19 fixedly attached to the snail 7. As shown, the profile of the snail 7 comprises a main part in the form of a spiral and a discontinuity 9 in the form of a drop arranged to connect the tip of the spiral to its lowest point. The device for coordinated actuation also comprises a first transmission member formed from a cam follower 11a and a toothed sector 11b, as well as a second transmission member comprising a cam follower 13a and a toothed sector 13b. It can be seen that, in the illustrated example, the first and the second transmission member are both pivoted on the same axis (referenced 21), and that their cam followers 11a and 13a are both arranged to cooperate with the profile of the snail 7. It can also be seen that the toothed sectors 11b, 13b of the two transmission members mesh with the pinions 3 and 5 respectively. Finally, the device for coordinated actuation comprises return means arranged to return the cam followers 11a and 13a against the profile of the snail 7. In the illustrated example, these return means comprise a first leaf spring (referenced 17).

The direction in which the movement (not shown) of the timepiece drives the snail 7 in rotation corresponds to the clockwise direction in FIGS. 1A and 1B. It will be understood that the spiral part of the profile corresponds to the rising part thereof. The cam followers 11a and 13a of the first and of the second transmission member are arranged to follow the profile of the snail 7 with a slight offset, the cam follower 13a being slightly behind with respect to the cam follower 11a. In the present example, the offset between the two cam followers corresponds to a duration of three minutes. As the cam 7 is driven by the movement at the rate of one turn in twelve hours, the offset existing between the two cam followers corresponds to the time necessary for the cam to pivot by 1.5°. It is worth noting that if the cam 7 were driven at the higher speed of one turn per hour, the cam would take only 15 seconds to pivot by 1.5°. Generally speaking, it is advantageous that the angle by which the cam pivots over the duration of the offset is less than 30°, and this angle is preferably less than 5°. Generally speaking, it is advantageous that the angle by which the cam pivots over the duration of the offset is greater than 1.2°, and this angle is preferably greater than 1.3°, preferably greater than 1.4°.

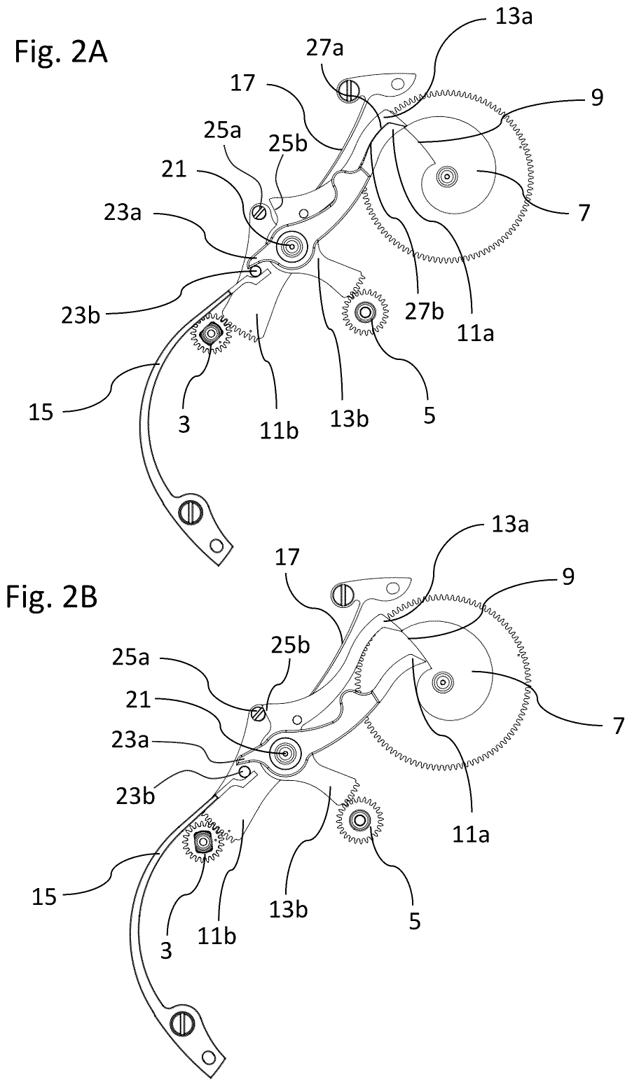

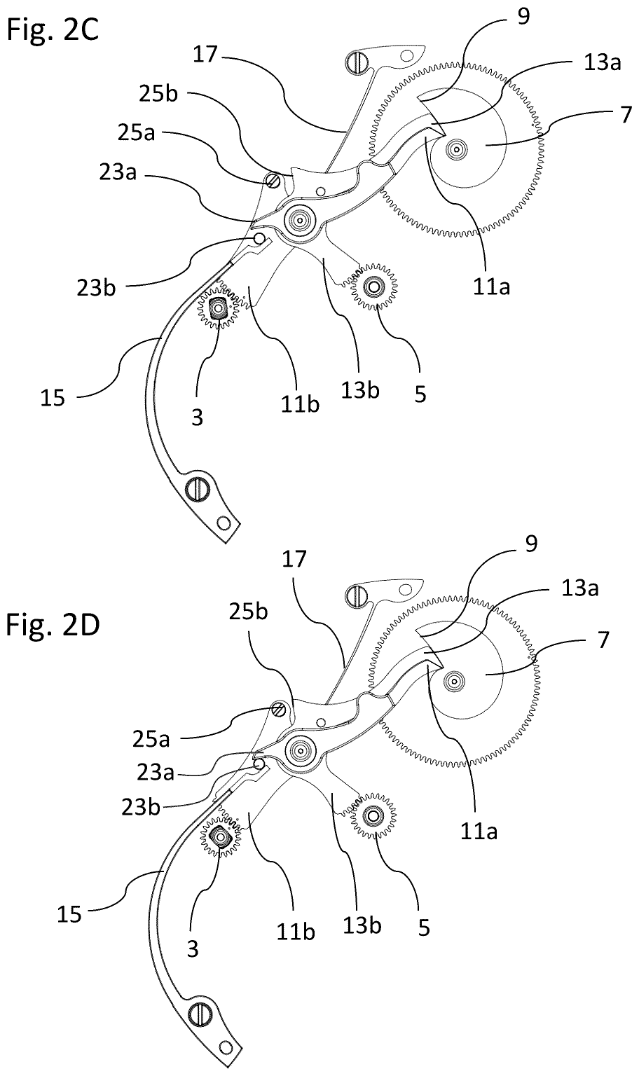

Referring now also to FIGS. 2A to 2D, it can be seen that the toothed sector 11b of the first transmission member carries an eccentric 25a, while the cam follower 13a of the second transmission member has a shoulder serving as a bearing surface 25b. As shown in FIG. 2B, the eccentric 25a and the bearing surface 25b are able to come into abutment against each other so as to block, in one direction, the pivoting of the toothed sector 11b with respect to the cam follower 13a. The main purpose of the stopping means which have just been described will be explained hereinunder.

As can be seen in FIGS. 1A and 1B, the cam followers 11a and 13a are arranged to pivot about the axis 21 in a same plane perpendicular to this axis. This arrangement has the advantage of rendering the device for coordinated actuation more compact, particularly in thickness. It can also be seen that the cam follower 13a is slightly longer than the cam follower 11a, and that its shape is adapted to enable it to cover the latter. Finally, it can be seen that the end of the cam follower 13a is curved so as to enable both cam followers to bear against the profile of the snail 7 at the same time, some clearance being then present between the surfaces 27a, 27b of the two cam followers.

In the illustrated example, the second transmission member forms a monobloc structure comprising two arms which are substantially perpendicular to each other. The two arms of the second transmission member are formed by the cam follower 13a and the toothed sector 13b respectively, these two elements being of one piece. In the illustrated example, the same is not true when it comes to the first transmission member. In fact, FIGS. 2A to 2D show that the toothed sector 11b and the cam follower 11a are articulated with respect to each other at the axis 21. It will be understood that these two elements can pivot about the axis 21 independently of each other. The cam follower 11a and the toothed sector 11b also share abutment means (23a, 23b). In fact, it can be seen that the cam follower 11a carries a finger 23a, and that the toothed sector 11b carries a pin 23b. As shown in FIGS. 2A and 2D, the pin 23b and the finger 23a are able to come into abutment against each other so as to block, in one direction, the pivoting of the toothed sector 11b with respect to the cam follower 11a. The finger 23a and the pin 23b thus form the abutment means shared by the cam follower 11a and the toothed sector 11b. However, it will be understood that different abutment means could be used. According to alternative variants, these abutment means could be of any type suitable for limiting the angular sector in which the cam follower 11a and the toothed sector 11b can pivot with respect to each other.

FIGS. 2A to 2D are four successive moments of the operation of the device in accordance with this first embodiment. In the illustrated example, the snail 7 is mounted in a coaxial position on the hour wheel (referenced 19) of the timepiece (the snail 7 is preferably made of the same piece of material as the hour wheel 19). It thus effects precisely one revolution in twelve hours. Still referring to the same figures, it will be noted that the first “snapshot” (FIG. 2A) shows the cam followers 11a and 13a arriving at the tip of the spiral just before the cam follower 11a falls into the discontinuity 9, and the fourth and last snapshot (FIG. 2D) shows the cam followers 11a and 13a right at the bottom of the drop, after the cam follower 13a has fallen into the discontinuity 9.

The actuation device according to this first embodiment also comprises a second leaf spring (referenced 15) which is arranged so that its distal end bears against the pin 23b of the toothed sector 11b. The toothed sector of the first transmission member is thus permanently subject to a return force which tends to cause it to pivot about the axis 21 (the direction in which the return force incites the toothed sector 11b to pivot corresponding to the clockwise direction in FIGS. 2A to 2D). The force exerted by the second leaf spring 15 on the toothed sector 11b also has the effect of returning the pin 23b in the direction of the finger 23a. Finally, when the pin 23b is located in abutment against the finger 23a as shown in FIGS. 2A and 2D, the force exerted by the second leaf spring 15 also has the effect of returning the cam follower 11a against the profile of the snail 7.

It has been seen that the cam followers 11a, 13a travel over the spiral part of the profile of the snail in an upwards direction. This rising part is arranged to raise the two cam followers progressively so as to cause them to pivot about the axis 21 (in the anti-clockwise direction in FIGS. 2A to 2D). When the cam follower 11a of the first transmission member pivots, its finger 23a repels the pin 23b of the toothed sector 11b against the return force exerted by the second leaf spring 15. Thus, by virtue of the presence of the abutment means 23a, 23b, the toothed sector 11b pivots in the anti-clockwise direction conjointly with the cam follower 11a. Finally, the pivoting of the toothed sector 11b drives the pinion 3 in the clockwise direction (as shown in FIGS. 2A to 2D). In an analogous manner, when the rising part of the snail 7 raises the cam follower 13a of the second transmission member, it causes it to pivot progressively about the axis 21 in the anti-clockwise direction, and it will be understood that when the second transmission member pivots in this way, the toothed sector 13b drives the pinion in the clockwise direction.

It will be understood, in particular, from the statements above, that the toothed sector 11b of the first transmission member and the toothed sector 13b of the second transmission member each reach an extreme angular position when the cam follower 11a or 13a of the same transmission member reaches the tip of the spiral part of the snail 7. Moreover, it will be understood that upon each revolution of the snail 7, the two toothed sectors 11b, 13b alternately pivot in one direction and the other from the extreme angular position associated with the tip of the snail 7 to an opposite extreme position. Referring now to the snapshot of FIG. 2A it can be seen that the cam followers 11a and 13a are located right at the top of the spiral of the snail 7, the cam follower 11a being located at the very edge of the discontinuity 9. It will be understood that, at the moment shown, the cam follower 11a has reached its position of maximum pivoting in the anti-clockwise direction. Furthermore, the cooperation of the abutment means 23a and 23b has resulted in the cam follower 11a having driven the toothed sector 11b with it, so that the latter has also reached its extreme angular position in the anti-clockwise direction. Finally, as the pinion 3 permanently meshes with the toothed sector 11b, it has also reached the end of its travel (in the clockwise direction).

The snapshot of FIG. 2B shows the device a few moments later. The cam follower 11a of the first transmission member has now fallen into the discontinuity 9, and it is the cam follower 13a of the second transmission member which is located at the edge of the discontinuity 9. Having crossed the discontinuity 9, the cam follower 11a is no longer supported by the profile of the snail 7. In this situation, it is free to pivot. Its finger 23a is thus no longer held in position and so the abutment means 23a, 23b are inoperative. In this situation, the second leaf spring 15 causes the toothed sector 11b to pivot in the clockwise direction so as to drive the pinion 3 in the anti-clockwise direction. It will be recalled that, in the present example, the pinion 3 is arranged to drive an animation (not shown) which the timepiece comprises.

It has been shown above that the toothed sector 11b has an eccentric 25a arranged to be able to come into abutment against a bearing surface 25b on the second transmission member so as to block the pivoting of the toothed sector 11b beyond a certain limit with respect to the cam follower 13a. In this situation, when the toothed sector 11b of the first transmission member pivots in the clockwise direction driven by the second leaf spring 15, the eccentric 25a comes into abutment against the bearing surface 25b. As shown in FIG. 2B, the meeting of the eccentric with the bearing surface interrupts the pivoting of the toothed sector 11b en route. Moreover, as the pinion 3 meshes with the toothed sector it also stops turning at the moment when the eccentric 25a comes into abutment against the bearing surface 25b. In an advantageous manner, the exact angular position at which the pinion 3 stops when the stopping means 25a, 25b interrupt the pivoting of the toothed sector 11b is chosen to coincide with a particular moment, e.g. a culmination point, in the unfolding of the animation. The synchronisation between the particular moment in the unfolding of the animation and the interruption in the pivoting of the toothed sector 11b can be adjusted by slightly turning the eccentric.

The snapshot of FIG. 2C shows the device a few moments later. The return force exerted by the first leaf spring 17 has now caused the cam follower 13a to fall into the discontinuity 9 after the cam follower 11a. As shown, the cam follower 13a has touched the bottom of the discontinuity 9, and it will be understood that, at the moment shown, it has reached its (opposite) extreme angular position in the clockwise direction. As far as the other cam follower 11a is concerned, it will be understood that, as long as the pin 23b has not arrived in abutment against the finger 23a, the cam follower 11a has not been subjected to the return force produced by the spring 15. At this stage, the cam follower 11a is thus free to rotate inside a space between the bottom of the discontinuity 9 and the side edge 27a of the cam follower 13a.

In accordance with the explanation above, the cam follower 13a of the second transmission member is arranged so as to be returned against the profile of the snail 7 by the first leaf spring 17. In this situation, when the cam follower 13a falls into the discontinuity 9, the first leaf spring 17 causes the second transmission member to pivot at an accelerated speed in the clockwise direction. The pivoting of the second transmission member causes the separation of the stopping means 25a, 25b so that the toothed sector 11b again drives the pinion 3 in the anti-clockwise direction, the animation thus being able to come to its finish. Furthermore, as the toothed sector 13b of the second transmission member meshes with the pinion 5, this pinion is driven in the anti-clockwise direction at an accelerated speed. It will be recalled that, in the present example, the pinion 5 is arranged to trigger the retrograde display of the time.

Finally, referring to FIG. 2D, it can be seen that the pin 23b is now located in abutment against the finger 23a, while the cam follower 11a is laid against the profile of the snail 7, the animation having been brought to its finish. It will be understood that the exemplified device which has just been described makes it possible to actuate an animation and a retrograde display of the time in a timepiece in a coordinated manner. This device makes it possible, in particular, to ensure that the triggering of the retrograde display of the time occurs at the desired moment in the unfolding of the animation.

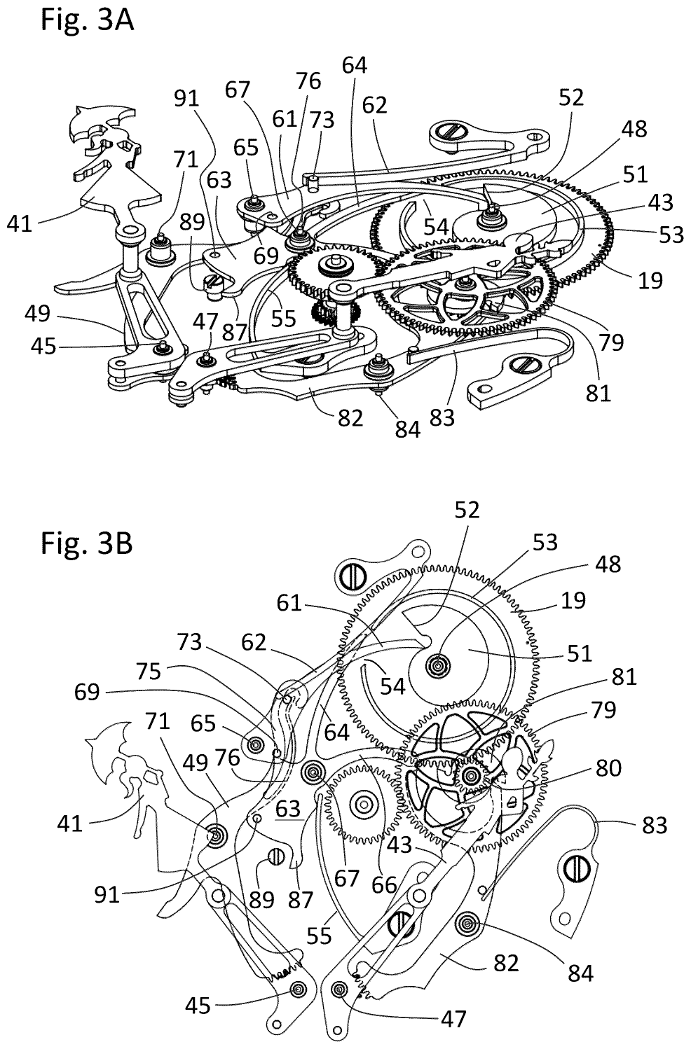

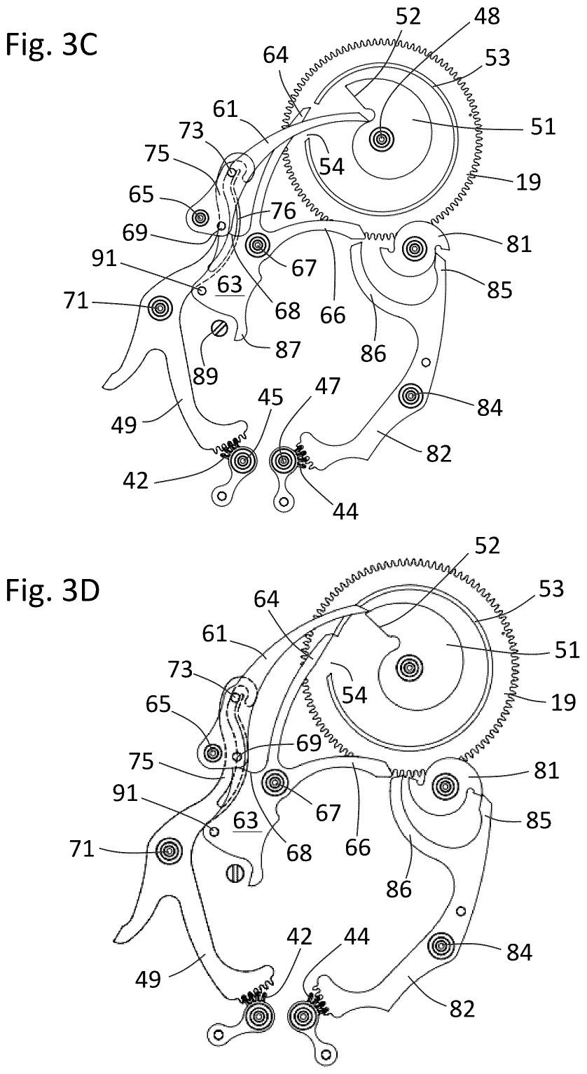

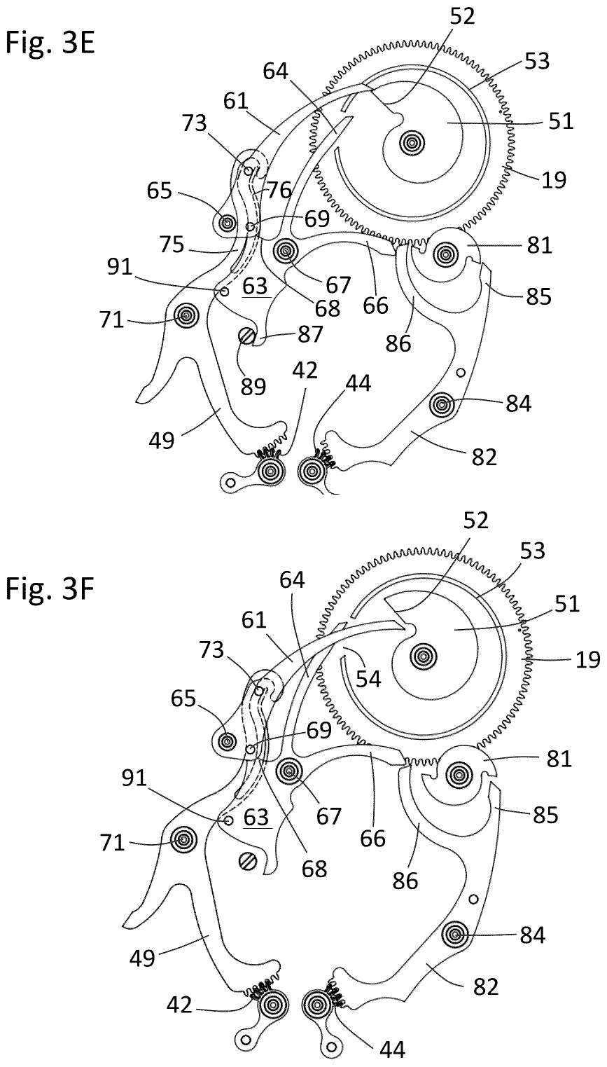

FIGS. 3A to 3F show a device for coordinated actuation of a retrograde display and of an animation according to a second embodiment of the invention. The retrograde display comprises a retrograde hour hand 41 and a retrograde minute hand 43. In the illustrated example, the retrograde hands 41, 43 are in the form of two people, the hour person having an umbrella. The retrograde hands 41, 43 are fixedly attached to two pinions with a toothed sector 42, 44, the spindles of which are referenced 45 and 47. On the other hand, as will be seen in more detail hereinunder, the function of the hands 41, 43 in the form of people is not limited to displaying the time. The two hands 41, 43 are also able to effect coordinated movements, the composition of which constitutes an animation. This is the reason why, in the following description, these hands are sometimes called animation members rather than retrograde hands.

Still referring to FIGS. 3A to 3F, it is also possible to see an hour mobile which is arranged to be driven about a spindle 48 by the timepiece movement at the rate of one revolution in 12 hours and a minute mobile which is arranged to be driven at the rate of one revolution in 120 minutes. The hour mobile comprises a wheel 19 as well as an hour cam 51 and an animation cam 53 which are both coaxial with the wheel 19 and fixedly attached thereto, the cams 51, 53 preferably being coplanar as shown in FIG. 3A in order to limit the thickness of the hour mobile. The direction in which the hour mobile is driven by the timepiece movement corresponds to the clockwise direction in FIGS. 3A to 3F. It can be seen that, in a conventional manner for a retrograde display, the hour cam 51 is a radial, snail-type cam, the profile of which is formed by a main part in the form of a spiral and of a discontinuity 52 in the form of a drop which connects the tip of the spiral to its lowest point. The radial animation cam 53 is more unusual. In fact, it consists of a ring interrupted by an opening which passes through the wall of the ring, this opening forming a discontinuity 54 in the profile of the cam 53. The hour mobile 19, 51, 53 is preferably monobloc. For its part, the minute mobile comprises a wheel 79, a pinion 80 and a minute cam 81 arranged coaxially and in a fixedly attached manner. The pinion 80 meshes with the wheel 19 in order to drive it. In the illustrated example, the minute cam 81 is in the form of a double snail. The direction in which the minute mobile is driven by the timepiece movement corresponds to the anti-clockwise direction in FIGS. 3A to 3F.

In a conventional manner for a retrograde display of the hours and minutes, the hands 41, 43 are controlled by an hour rack 49 and a minute rack 82 respectively. Each of the two racks 49, 82 is pivoted about a spindle (71 and 84 respectively) and its toothed sector meshes with the pinion 42, 44 which carries the corresponding retrograde hand 41, 43. The neck of the minute rack 82 terminates in a cam follower finger 85 which is returned against the profile of the minute cam 81 by a leaf spring 83 or other spring means. It will be understood that the elements just described enable the minute cam 81 to control the retrograde minute hand 43. As already mentioned, the minute cam 81 is driven at the speed of one turn in two hours. However, this cam has rotational symmetry of order 2. The minutes rack 82 and the retrograde minute hand 43 are thus driven in a cycle which is repeated every sixty minutes.

FIGS. 3A to 3F again show a first transmission member arranged to make it possible for the hour cam 51 to control the retrograde hour hand 41. In the illustrated example, the first transmission member is formed by the hour rack 49 which is pivotably mounted on the spindle 71, as well as by a cam follower lever 61 which is pivotably mounted on a spindle 65 and which is arranged to cooperate with the profile of the hour cam 51 under the action of a return leaf spring 62 or other spring means. The hour rack 49 and the cam follower lever 61 are coupled to each other by means of a pin 73 which is rigidly fixed to the lever 61 and which passes through the lever 61 parallel to its spindle 65. A portion of the pin 73 protruding with respect to one of the surfaces of the lever 61 serves as a bearing point for the free end of the leaf spring 62 and thus receives from this leaf spring the force enabling the lever 61 to be returned against the hour cam 51. A portion of the pin 73 protruding with respect to the opposite surface of the lever 61 is interposed between a rigid arm 75 of the neck of the hour rack 49 and an elastic arm 76 of the same neck, the pin 73 being easily able to slide in the longitudinal groove formed by the arms 75, 76, being clamped by the elastic arm 76 against the rigid arm 75.

FIGS. 3A to 3F again show a second transmission member arranged to make it possible for the animation cam 53 to control the two animation members or retrograde hands 41, 43. The second transmission member comprises an animation rocker 63 which is provided with a cam follower finger 64 arranged to cooperate with the profile of the animation cam 53. The animation rocker 63 is pivoted on a spindle 67, and a leaf spring 55 or other spring means is again provided in order to return the cam follower finger 64 against the profile of the animation cam 53. An eccentric 89 can again be seen, which is mounted on the frame of the device for coordinated actuation 14—typically the frame of the timepiece movement—and which is arranged to be able to cooperate with a lug 87 on the animation rocker 63. As shown in FIG. 3E, the lug 87 is able to come into abutment against the eccentric 89 so as to block the pivoting of the animation rocker 63 in the clockwise direction.

The animation rocker 63 carries a second pin 91 arranged to cooperate with a flank of the hour rack 49 in order to drive the hour rack 49 in the anti-clockwise direction when the animation rocker 63 pivots in the clockwise direction, i.e. when the cam follower finger 64 falls into the drop 54 of the profile of the animation cam 53.

It can also be seen that the cam follower lever 61 carries a third pin 69 arranged to cooperate with a shoulder 68 of the animation rocker 63. When the cam follower lever 61 crosses the tip of the profile of the hour cam 51 and falls into its discontinuity 52, the pivoting of the lever 61 in the clockwise direction leads to the pin 69 causing the animation rocker 63 to pivot in the anti-clockwise direction.

The hour cam 51, the animation cam 53, the cam follower lever 61 and the cam follower finger 64 are arranged so that the falls of the cam follower lever 61, which take place periodically with the same period as the falls of the cam follower finger 64, are offset in time with respect to the falls of the cam follower finger 64. In a typical example, the offset between the two cam followers 61, 64 corresponds to a duration of three minutes. As the hour mobile 19, 51, 53 is driven by the timepiece movement at the rate of one turn in twelve hours, the offset existing between the two cam followers 61, 64 corresponds to the time necessary for the hour mobile 19, 51, 53 to pivot by 1.5°. Generally speaking, it is advantageous that the angle by which the hour mobile 19, 51, 53 pivots over the duration of the offset is less than 30°, and this angle is preferably less than 5°. Generally speaking, it is advantageous that the angle by which the hour mobile 19, 51, 53 pivots over the duration of the offset is greater than 1.2°, and this angle is preferably greater than 1.3°, preferably greater than 1.4°.

The device according to this second embodiment functions in the following manner. At the start of the operational cycle (FIGS. 3A, 3B and 3C), just after midday or midnight, the cam follower lever 61 and the cam follower finger 85 bear against the bottom of the hour cam 51 and of the minute cam 81 respectively, and the hour and minute hands 41, 43 have angular positions spaced apart from each other, forming a V, these positions referred to as zero positions. The rotation of the hour and minute cams 51, 81 causes the cam follower lever 61 to rise progressively (in the anti-clockwise direction) and the cam follower finger 85 to rise progressively (in the clockwise direction). By means of its pin 73 the cam follower lever 61 drives the hour rack 49 which itself, by means of the pinion 42, drives the hour hand 41 in the clockwise direction along an arcuate hour scale until (a little less than 12 hours after the start of the cycle) the cam follower lever 61 arrives at the tip of the hour cam 51 (FIG. 3D) corresponding to a substantially vertical position of the hour hand 41.

The raising of the cam follower finger 85 and of the minute rack 82 to which it appertains by the minute cam 81 causes the minute hand 43 to pivot by means of the pinion 44 in the anti-clockwise direction along an arcuate minute scale. Every sixty minutes the cam follower finger 85 falls along one of the two drops of the minute cam 81, which causes the minute hand 43 to return to its zero position. The minute hand 43 thus moves alternately in the anti-clockwise direction (progressively) and in the clockwise direction (suddenly) while the hour hand 41 advances progressively in the clockwise direction. Throughout this time, the animation rocker 63 is held by the pin 69 of the cam follower lever 61 (when the lever 61 bears against the bottom of the hour cam 51; FIGS. 3A to 3C) or by the animation cam 53 (the rest of the time; FIG. 3D) in an angular position where it acts neither on the hour tack 49 nor on the minute rack 82.

A little before midday or midnight (FIG. 3D), for example one to three minutes before midday or midnight, the cam follower lever 61 is located almost at the tip of the hour cam 51, the cam follower finger 85 is located almost at one of the two tips of the minute cam 81 and the hour and minute hands 41, 43 are close to each other, in substantially vertical positions, almost at the maximum of the arcuate scales. In this configuration, the pin 69 carried by the cam follower lever 61 is not in the pivoting path of the animation rocker 63 and of its shoulder 68. The cam follower finger 64 of the animation rocker 63, which until then was sliding on the animation cam 53, falls into the discontinuity 54 under the action of its return spring 55 (FIG. 3E), which triggers the animation (automaton). In concrete terms, the pin 91 of the animation rocker 63 comes into contact with the hour rack 49 and causes it to pivot in the anti-clockwise direction. Simultaneously, an activation finger 66 of the animation rocker 63 comes into contact with an arm 86 of the minute rack 82 in order to cause the minute rack 82 to pivot in the clockwise direction. These displacements, which stop when the lug 87 of the animation rocker 63 abuts against the eccentric 89, drive the hour and minute hands 41, 43 to move further towards each other, out of the arcuate hour and minute scales, so as to give the impression that the two people are giving each other a kiss. The displacement of the hour rack 49 by the pin 91 has no effect on the position of the cam follower lever 61, which continues to bear against the hour cam 51 under the action of its return spring 62, the elastic arm 76 in contact with the pin 73 deforming to allow said displacement as shown in FIG. 3E. It will be understood that the eccentric 89 serves as a means for adjusting the relative angular position occupied by the minute and hour hands 41, 43 at the culmination point of the animation, i.e. at the moment of the kiss.

Then (FIG. 3F), after a time corresponding to the duration of the offset between the two cam followers 61, 64 (typically three minutes, as already indicated), the cam follower lever 61 falls into the discontinuity 52 of the profile of the hour cam 51. During this fall, the pin 69 of the cam follower lever 61 acts on the shoulder 68 in order to cause the animation rocker 63 to rise and to release it from any interaction with the hour rack 49 and the minute rack 82. By its cooperation with the elastic arm 76, the pin 73 of the cam follower lever 61 drives the hour rack 49 in the clockwise direction. Simultaneously, the cam follower finger 85 falls into one of the drops of the minute cam 81, which corresponds to a pivoting of the minute rack 82 in the anti-clockwise direction. The hour and minute hands 41, 43 thus suddenly return to their zero position from the culmination point of the animation. The 12 hour cycle is terminated.

It will be understood that the exemplified device which has just been described makes it possible to actuate an animation and a retrograde display of the time in a timepiece in a coordinated manner. This device makes it possible, in particular, to ensure that the triggering of the retrograde display of the time occurs at the desired moment in the unfolding of the animation.

The present invention is not limited to a retrograde display of the time coordinated with an animation. For example, it could be applied to a regatta watch comprising a first function consisting of producing striking slightly ahead of the start of the race and a second function consisting of producing new striking at the moment of the start.

It will also be understood that various modifications and/or improvements obvious to a person skilled in the art can be made to the embodiments being described in the present description without departing from the scope of the present invention defined by the accompanying claims. In particular, the device of the invention can be arranged to coordinate a larger number of functions or mechanisms and, to this effect, can comprise a larger number of cams and a larger number of transmission members. Furthermore, although the coaxial arrangement of the cams 51, 53 in the second embodiment is preferred for reasons of precision, space and simplicity of assembly, these cams could be part of two different mobiles, e.g. two mobiles connected by gearing, in so far as they turn at the same angular speed and their relative angular position (adjustable e.g. by an eccentric) is chosen in order to obtain the desired time offset between the falls of the cam follower lever 61 and those of the cam follower finger 64.

1. Device for coordinated actuation of two functions of a timepiece, the device comprising:
one or a plurality of cams (7; 51, 53) arranged to be driven by the movement of the timepiece and of which the respective profile or profiles each comprise a discontinuity (9; 52, 54);
a first (11a, 11b; 49, 61) and a second (13a, 13b; 63) transmission member each comprising a cam follower (11a, 13a; 61, 64), the cam follower (11a; 61) of the first transmission member being arranged to cooperate with the profile of the cam (7) or of a first (51) of said cams (51, 53) and to fall periodically into the discontinuity (9; 52) of the profile of the cam (7) or of said first (51) of said cams (51, 53), the cam follower (13a; 64) of the second transmission member being arranged to cooperate with the profile of the cam (7) or of a second (53) of said cams (51, 53) and to fall periodically, with the same period as the falls of the cam follower (11a; 61) of the first transmission member, into the discontinuity (9; 54) of the profile of the cam (7) or of said second (53) of said cams (51, 53), the falls of the cam follower (11a; 61) of the first transmission member being offset in time with respect to those of the cam follower (13a; 64) of the second transmission member.

2. Device for coordinated actuation as claimed in claim 1, characterised in that the offset between the cam followers (11a, 13a; 61, 64) is equal to the time necessary for the cam (7) or for the cams (51, 53) to turn by a predetermined angle when they are driven by the movement, the predetermined angle preferably being less than 30°, preferably less than 5°, and preferably being greater than 1.2°, preferably greater than 1.3°, preferably greater than 1.4°.

3. Device for coordinated actuation as claimed in claim 1, characterised in that said one or said plurality of cams consists of a snail (7), the cam followers (11a, 13a) of the first and of the second transmission members both being arranged to cooperate with the profile of the snail (7), and in that the cam followers (11a, 13a) of the first and of the second transmission members are arranged to follow the profile of the snail (7) with an offset, the cam follower (11a) of the first transmission member being in advance with respect to the cam follower (13a) of the second transmission member.

4. Device for coordinated actuation as claimed in claim 3, characterised in that it comprises return means (15, 17) arranged to return the cam followers (11a, 13a) of the first and second transmission members against the profile of the snail (7), said snail (7) comprising a rising profile terminating by a drop forming said discontinuity (9), and in that the first and second transmission members each further comprise a toothed sector (11b, 13b) arranged in order, during each revolution of the snail (7), to pivot alternately in one direction and the other from an extreme angular position associated with the tip of the profile of the snail to an opposite extreme angular position.

5. Device for coordinated actuation as claimed in claim 4, characterised in that the first and the second transmission members share stopping means (25a, 25b) arranged to stop the toothed sector (11b) of the first transmission member in a predetermined intermediate angular position when the toothed sector (11b) of the first transmission member pivots in the direction of the opposite extreme angular position following the fall of the cam follower (11a) of the first transmission member into the discontinuity (9) of the profile of the snail (7).

6. Device for coordinated actuation as claimed in claim 5, characterised in that the stopping means (25a, 25b) are rendered inoperative by the fall of the cam follower (13a) of the second transmission member into the discontinuity (9), the toothed sector (11b) then being free to pivot from the intermediate angular position to the opposite extreme angular position.

7. Device for coordinated actuation as claimed in claim 3, characterised in that the first and the second transmission members are pivoted about the same axis (21).

8. Device for coordinated actuation as claimed in claim 7, characterised in that the cam followers (11a, 13a) of the first and of the second transmission member are arranged to pivot about the axis (21) in the same plane.

9. Device for coordinated actuation as claimed in claim 3, characterised in that:
the toothed sector (11b) and the cam follower (11a) of the first transmission member are articulated on the axis (21) so as also to enable them to pivot with respect to each other about the axis (21), while the toothed sector (13b) and the cam follower (13a) of the second transmission member are fixedly attached to each other; and
the cam follower (11a) and the toothed sector (11b) of the first transmission member share abutment means (23a, 23b) limiting the angular sector in which they can pivot with respect to each other, and enabling the cam follower (11a) to drive the toothed sector (11b) with it when it pivots, being raised by the rising profile of the snail (7).

10. Device for coordinated actuation as claimed in claim 3, characterised in that the stopping means comprise an eccentric (25a) and a bearing surface (25b), the eccentric being carried by one of the second transmission member and the toothed sector (11b) of the first transmission member, and the bearing surface forming part of the other of the second transmission member and the toothed sector (11b) of the first transmission member.

11. Device for coordinated actuation as claimed in claim 10, characterised in that the bearing surface (25b) and the eccentric (25a) are arranged to be able to come into abutment against each other so as to block, in one direction, the pivoting of the toothed sector (11b) of the first transmission member with respect to the cam follower (13a) of the second transmission member.

12. Device for coordinated actuation as claimed in claim 3, characterised in that the stopping means comprise an eccentric (25a) which carries the toothed sector (11b) of the first transmission member, and a bearing surface (25b) on the second transmission member, the eccentric (25a) and the bearing surface (25b) being arranged to be able to come into abutment against each other so as to block, in one direction, the pivoting of the toothed sector (11b) of the first transmission member with respect to the cam follower (13a) of the second transmission member.

13. Device for coordinated actuation as claimed in claim 1, characterised in that said one or said plurality of cams comprise said first cam (51) arranged to cooperate with the cam follower (61) of the first transmission member (49, 61) and said second cam (53) arranged to cooperate with the cam follower (64) of the second transmission member (63).

14. Device for coordinated actuation as claimed in claim 13, characterised in that the first and second cams (51, 53) are coaxial and fixedly attached.

15. Device for coordinated actuation as claimed in claim 14, characterised in that the first and second cams (51, 53) form, or form part of, a monobloc assembly.

16. Device for coordinated actuation as claimed in claim 13, characterised in that the first cam (51) is a snail.

17. Device for coordinated actuation as claimed in claim 13, characterised in that the second cam (53) has a circular profile interrupted by the discontinuity (54).

18. Device for coordinated actuation as claimed in claim 13, characterised in that the second transmission member (63) is a rocker.

19. Device for coordinated actuation as claimed in claim 13, characterised in that the first transmission member comprises a rack (49) coupled to the cam follower (61) of the first transmission member.

20. Device for coordinated actuation as claimed in claim 19, characterised in that the second transmission member (63) is arranged to move the rack (49) when the cam follower (64) of the second transmission member (63) falls into the discontinuity (54) of the profile of the second cam (53).

21. Device for coordinated actuation as claimed in claim 13, characterised in that the second transmission member (63) is arranged to act upon the first transmission member (49, 61) when the cam follower (64) of the second transmission member (63) falls into the discontinuity (54) of the profile of the second cam (53).

22. Device for coordinated actuation as claimed in claim 20, characterised in that the cam follower (61) of the first transmission member is arranged in order, as it falls into the discontinuity (52) of the profile of the first cam (51), to cause the cam follower (64) of the second transmission member (63) to rise out of the discontinuity (54) of the profile of the second cam (53).

23. Device for coordinated actuation as claimed in claim 20, characterised in that it comprises a third cam (81) and a third transmission member (82) comprising a cam follower (85) arranged to cooperate with the profile of the third cam (81), the second transmission member (63) being arranged to act on the third transmission member (82) when the cam follower (64) of the second transmission member (63) falls into the discontinuity (54) of the profile of the second cam (53).

24. Device for coordinated actuation as claimed in claim 23, characterised in that the third transmission member (82) is a rack.

25. Device for coordinated actuation as claimed in claim 23, characterised in that the third transmission member (82) is arranged to actuate a first retrograde display, preferably a retrograde minute display.

26. Device for coordinated actuation as claimed in claim 13, characterised in that the first transmission member (49, 61) is arranged to actuate a second retrograde display, preferably a retrograde hour display.

27. Device for coordinated actuation as claimed in claim 26, characterised in that the second transmission member (63) is arranged to actuate an animation using an indicating hand (41) of the second retrograde display.

28. Device for coordinated actuation as claimed in claim 25, characterised in that the second transmission member (63) is arranged to actuate an animation using an indicating hand (41, 43) of each of the first and second retrograde displays.

29. Device for coordinated actuation as claimed in claim 1, characterised in that one of the two functions is a function of displaying a physical magnitude and in that the other of the two functions is an animation function, preferably an automaton function.

30. Timepiece comprising two functions and a device as claimed in claim 1 to actuate the two functions in a coordinated manner.
